(19) United States
(12) Patent Application Publication
(10) Pub. No.: US 2012/0160110 A1
(43) Pub. Date: Jun. 28, 2012

(54) GRILL/TOASTER MACHINE WITH VAPOR

(75) Inventor: Mete GÜRSEL, Istanbul (TR)

(73) Assignee: ERNA-MAS MAKINE TICARET VESANAYIANONIM SIRKETI, Istanbul (TR)

(21) Appl. No.: 13/011,073

(22) Filed: Jan. 21, 2011

(30) Foreign Application Priority Data
Dec. 23, 2010 (TR) A2010/10783

(51) Int. Cl. A47J 43/18

(52) U.S. Cl. 99/426

(57) ABSTRACT

The invention is a grill/toaster machine with vapor, characterized in that there is a mechanism which provides that the water vapor, the amount of which is controlled, is given as to be homogeneously distributed into the food materials to be cooked, between two heater plates during the cooking process.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

INCORPORATION-BY-REFERENCE OF MATERIALS SUBMITTED ON A COMPACT DISC

Not applicable.

### BACKGROUND OF THE INVENTION

1. Field of the Invention

The invention is a grill/toaster machine with vapor. It is characterized in that there is a mechanism which provides that the water vapor, the amount of which is controlled, is given as to be homogeneously distributed into the food materials to be cooked, between the two heater plates (1-2) during the cooking process.

2. Description of Related Art Including Information Disclosed Under 37 CFR 1.97 and 37 CFR 1.98

The standard grill/toaster machines existing in the market

As it is known, the devices which are known as toaster machines and standard grills are defined as an Electric Grill, Barbecue Grill, Charcoal Grill, Gass Grill, Countertop Grill, and Indoor and Outdoor Grill in English.

The said “grill/toaster machine with vapor” has a top and bottom heating plates which operate opening and closing by means of a hinge mechanism.

The devices may be in different sizes.

The devices may be heated by electricity or gas.

The devices may be used on the table.

The devices may be used in open air and mounted on feet.

The heat of the plates of the devices may be controlled by a thermostat or there may not be a heat control.

Cooking Process

In the toaster machines, meat parts, meat balls, steak, chicken, fish, sausage, cheese between two bread slices and toast with charcuteries are prepared by cooking between the heated top and bottom plates. During this cooking process, depending on the food material cooked, the temperature level may be set by means of the thermostat in the heater which heats the plates, or no setting may be done depending on the desire of the user.

### BRIEF SUMMARY OF THE INVENTION

The present invention is that there is a mechanism in the grill/toaster machine which provides that the water vapor, the amount of which is controlled, is given as to be homogeneously distributed into the food materials to be cooked, between the two heater plates during cooking process of all kinds of the grill/toaster machines defined above.

### BRIEF DESCRIPTION OF THE SEVERAL VIEWS OF THE DRAWINGS

FIG. 1 is a perspective view of the grill/toaster machine with vapor wherein the cap is opened.

FIGS. 2.a and 2.b are front views of the grill/toaster machine with vapor wherein the cap is closed.

FIG. 3 is a side view of the grill/toaster machine with vapor wherein there is a food material inside.

FIG. 4 is a top view of the grill/toaster machine with vapor wherein the cap is closed.

The description of the numbers stated in the figures:

(1) The bottom heater plate;

(1.a) The heaters of the bottom plate;

(2) The top heater plate;

(2.a) The heaters of the top plate;

(3) The water chamber in the bottom plate;

(3.a) The heaters of the bottom water chamber;

(4) The heater part which gets into the chamber in the center of the top heater plate (a protrusion which partially gets into the water chamber);

(4.a) The heater of the top protrusion;

(5) The removable water/oil collecting chamber;

(6) The body which carries the heaters of the bottom plate (bottom body);

(7) The body which carries the heaters of the top plate (top body);

(8) Handle;

(9) The display for maximum water level;

(10) The thermostat setup button of the top heater;

(11) The thermostat setup button of the bottom heater;

(12) The thermostat setup button of the water chamber heater with display with light; and

(13) The control panel.

### DETAILED DESCRIPTION OF THE INVENTION

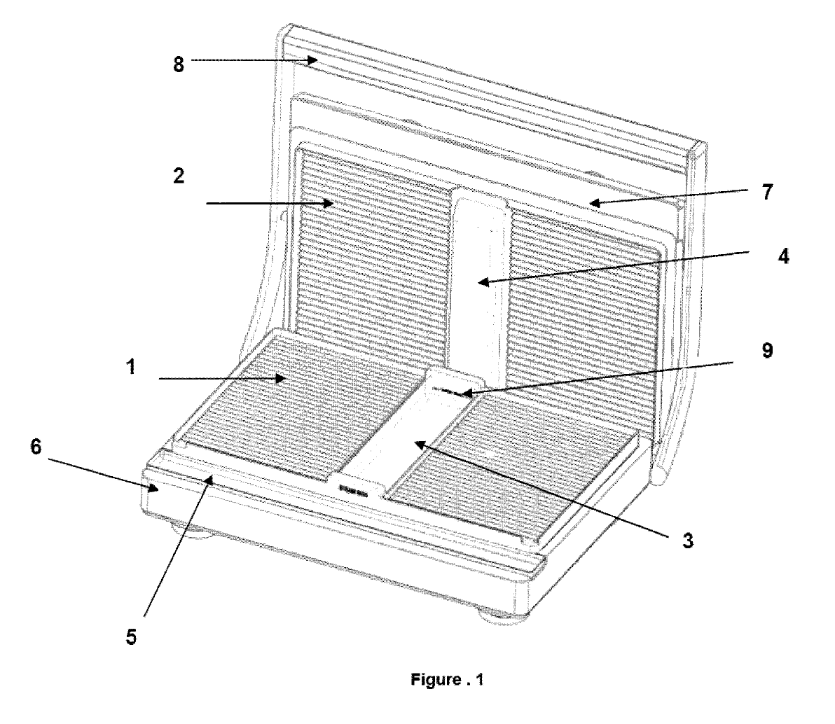

There is a cavity water chamber (3) which is created on the top heater plate (1) of the grill/toaster machine which is seen in FIG. 1.

There is a protrusion (4) on the top heater plate (2), which is partially into the water chamber (3) in the center of the bottom plate (1).

There is a collecting chamber (5) which collects the oils and the water which leaves the foods on the bottom heater plate (1) and which may be removed and cleaned.

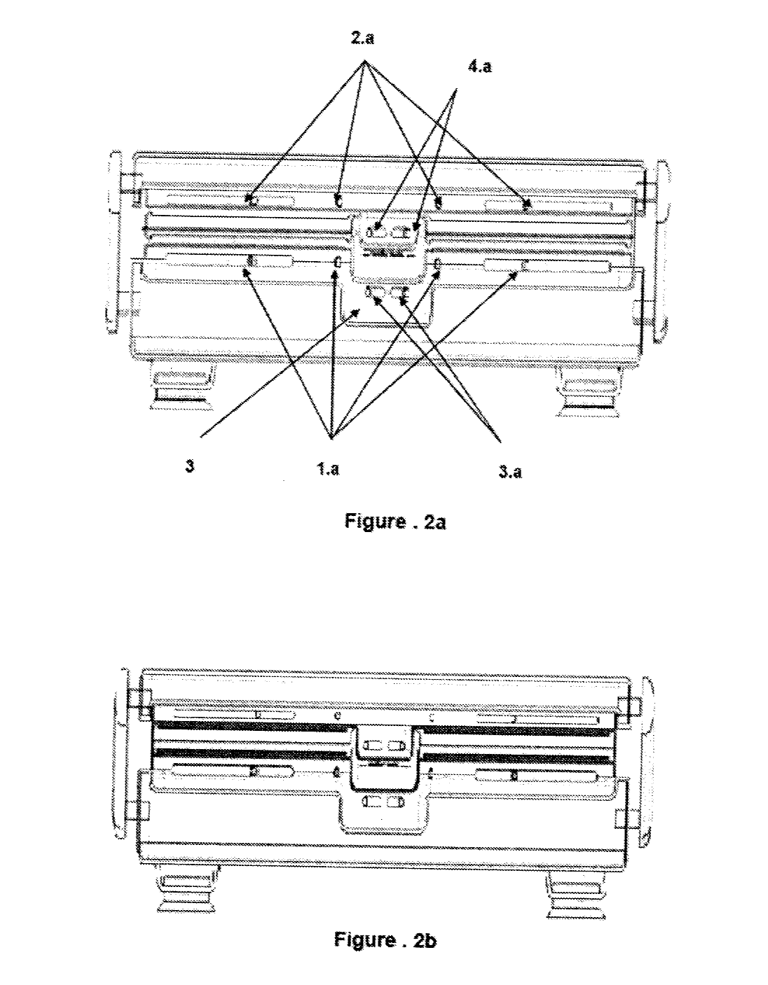

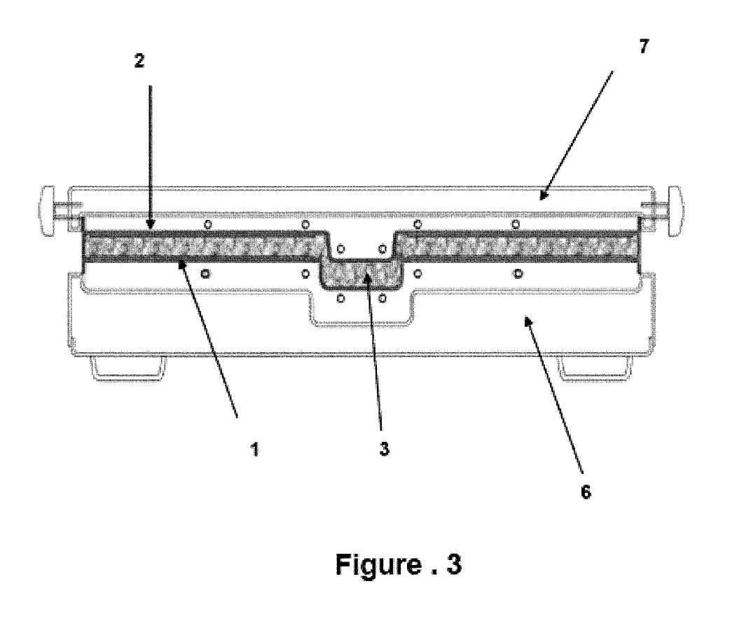

As it can be seen in FIG. 2, the water in the bottom chamber (1) is rapidly heated and vaporized by means of the water chamber heaters (3.a) in the bottom plate and the heater of the protrusion part (4.a) of the top plate. The obtained free vapor penetrates into the food materials between the both bottom and top heater plates (1-2) as it can be seen in FIG. 3.

The peripheral walls of the bottom and top heater plates (1-2) are formed for preventing the vapor which is produced in the device and enters into the foods when the toaster machine is closed from going out of the device.

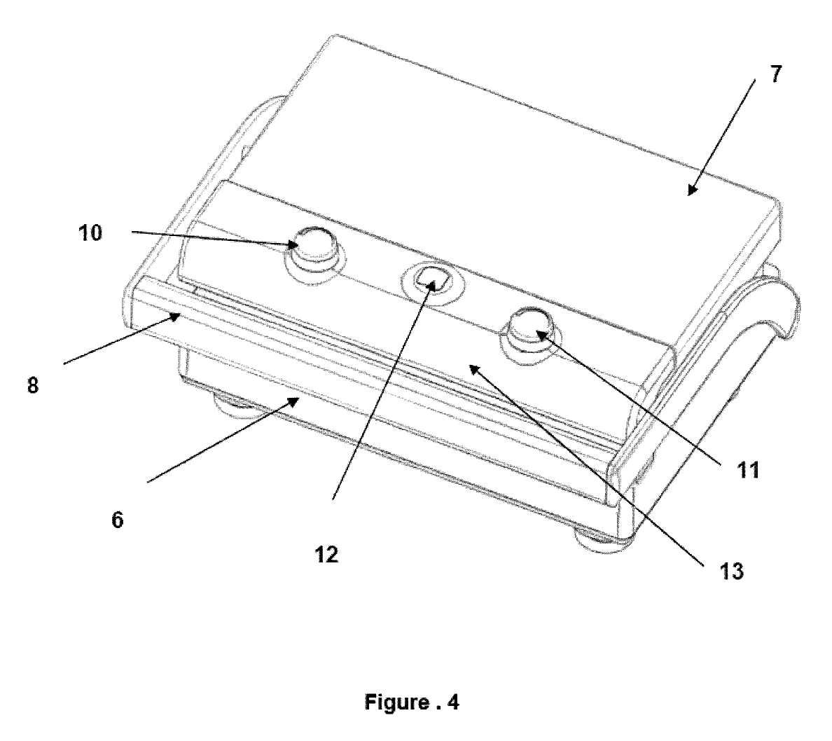

As can be seen in FIG. 4, it is provided that the vapor is penetrated into the foods without losing time during cooking as the water chamber heater is activated some time before the top and bottom plate heaters by the thermostat setup button (12).

The Advantages of the Invention

When compared, the grill toaster machine with vapor cooks in a shorter time than the normal grill toaster machine.

When compared, the grill toaster machine with vapor emits less odor.

When compared, the grill toaster machine with vapor, during cooking, because the fats in the meats are washed away together with the vapor, instead of cooking together with the meat, the user can have a fat free food.

When compared, the grill toaster machine with vapor, the cooked foods obtained such as meat, chicken etc. are soft and juicy and can be cut more easily.

When compared, the grill toaster machine with vapor, although the cooked materials may partially or completely stick to the top or bottom plate in the classical type grill/toaster machines, the whole surfaces of the foods in the classical type grill/toaster machines with vapor cooked in the same way and don't stick on the plates.

When compared, the grill toaster machine with vapor, during cooking, the juice of the food materials does not flow out by the effect of the vapor and the taste is kept inside.

When compared, the grill toaster machine with vapor, the cooked food materials taken out of the classical type grill/toaster machines dry and harden a very short time after served in the table whereas the ones taken out of the grill/toaster machine with vapor keep being soft and with juice.

When compared, the grill toaster machine with vapor, the food materials placed between the plates of the classical type grill/toaster machines are shrunk by losing water, whereas they are thickened and become bigger by means of the vapor during cooking in the grill/toaster machine with vapor.

When compared, the grill toaster machine with vapor, although the things such as meats, chickens, etc. which need to be cooked after taken from the deep freezer are heated in the classical type grill/toaster machines, cooking and burning may be seen in the top and bottom parts, the middle parts may stay cold, unfrozen. However the frozen foods cooked in grill/toaster machine with vapor are cooked equally in every parts and sides, similar to the non-frozen ones.

When compared, the top and bottom plates of the type grill/toaster machines with vapor can be cleaned easily after usage, whereas this process is hard and takes time in the conventional grill/toaster machines.

1. A grill/toaster machine having a mechanism which has a water chamber added in any of the bodies and produces water vapor by means of a electrical or gas heater placed on this chamber, it is characterized in that the water vapor produced in the water chamber is sprayed on food materials by means of water chamber heaters in the bottom plate and the heaters of a protrusion part of the top plate.

2. The grill/toaster machine of claim 1, characterized in that the heater plates are fixed or movable in the device.

3. The grill/toaster machine of claim 1, characterized in that the water chamber and the heater of the device are fixed or movable.

4. The grill/toaster machine of claim 1, characterized in that the heater of the device which produces vapor is controlled by means of a thermostat or is without thermostat.
